(19) United States
(12) Patent Application Publication
(10) Pub. No.: US 2017/0320115 A1
(43) Pub. Date: Nov. 9, 2017

(54) METHOD OF EQUAL CHANNEL ANGULAR EXTRUSION

(71) Applicant: ENGINEERED PERFORMANCE MATERIALS COMPANY, LLC, Whitmore Lake, MI (US)

(72) Inventor: Vladimir M. Segal, Howell, MI (US)

(21) Appl. No.: 15/587,858

(22) Filed: May 5, 2017

Related U.S. Application Data
(60) Provisional application No. 62/332,801, filed on May 6, 2016.

(51) Int. Cl. B21C 23/00; B30B 11/26; B21C 23/01; B21C 33/00; B21C 23/12

(52) U.S. Cl. CPC B21C 23/001; B30B 11/265; B21C 23/01; B21C 23/12; B21C 33/004

(57) ABSTRACT

The present invention relates to improvements of equal channel angular extrusion (ECAE). It provides a preservation of billet shape, a simple billet ejection from tool, application of backpressure and minimizes or eliminates flashes and cracks during multi-pass processing. That way, ECAE can be performed at a large scale as a productive and cost effective industrial operation without billet reshaping and preheating between passes.

### CROSS-REFERENCE TO RELATED APPLICATION(S)

This application claims the benefit of U.S. Provisional Application No. 62/332,801, which was filed on May 6, 2016. The aforementioned provisional application is incorporated herein by reference in its entirety.

### FIELD OF THE INVENTION

The invention relates to equal channel angular extrusion (ECAE) or equal channel angular pressing (ECAP) as a technique of severe plastic deformation to control material structure and properties. More specifically, it relates to ECAE of batch billets such as large square plates or long square rods.

### BACKGROUND OF THE INVENTION

ECAE is an effective technique to control material structure and modify properties. ECAE is performed by extruding of well-lubricated billets between two intersecting channels of the identical cross-section areas. Different methods and apparatus for realization of ECAE were suggested. For batch billets, they can be divided on processing in solid dies and in dies with movable walls. Solid ECAE dies were described in patents of U.S. Pat. No. 5,590,389; U.S. Pat. No. 5,904,062; U.S. Pat. No. 6,209,379; US No. 2012/0178892; EP 1 787 735; EP 2 554 285; WO/2010/049950; RU 2146571, and other. However, even the best lubricants cannot provide low friction in channels and stable processing. For that reason, ECAE in solid dies is associated with large extruding pressures and loads, material sticking to tool, low productivity and high cost.

More effective are dies in which some channel walls can move together with material during extruding. Movable walls eliminate friction, prevent material galling, reduce pressure and load, and transform ECAE into a practical operation. Related concepts of ECAE were suggested in patents USSR Nos. 780293, 902962; U.S. Pat. Nos. 5,400,633; 6,723,187, 7,380,432, and other. FIG. 1A shows a typical case of the prior art for ECAE of batch billets. The tool comprises a die 1 having a vertical channel 2 and horizontal channel 3, a base 4, a movable slider 5, a punch 6, and a hydraulic cylinder 7. The die 1 is fixed in the base 4 which is attached to a bottom plate 9. The cylinder 7 operates the slider 5, which forms a bottom wall of the horizontal channel. In the original position (FIG. 1A), a well-lubricated billet 8 is inserted in the vertical channel 2. When the punch 6 extrudes the billet into channel 3, the slider 5 moves together with the material. After completion a stroke (FIG. 1B), the punch slightly retreats, the hydraulic cylinder moves slider into an opposite direction to the extrusion direction until full release of the billet (FIG. 1C), and punch 6 ejects billet from the die (FIG. 1D). Finally, punch and slider return to the original position and billet is ejected from the tool in the same direction as the extrusion (FIG. 1E).

The prior art has a few shortcomings. First, as the horizontal channel is open, the front billet end after extruding exhibits significant distortion and barreling. Typical bowing of plate billets is shown in FIG. 2. Such bowing is not desirable because the billets are typically subjected to multiple passes through the same die. It is desirable that the billet retains its shape for the multiple passes without the need for additional reshaping between passes. To insert billet into the channel at the next pass, it should be rotated 90° and cut to the size A.

Second, a clearance between punch and vertical channel results in a flash B at the top billet surface (FIG. 2). To prevent cracks at this surface, an inner edge of the channel intersection on the die needs a radius R shown in FIG. 5. However, a massive flash B (FIG. 2) formed on the billet does not allow billet to be inserted into the channel for the next pass and the flash must be machined or trimmed from the billet. Additional operations of cutting, machining or trimming lead to material cooling after each pass and reheating before next pass that significantly increases the time and cost of ECAE, especially for large plate billets and warm or hot processing conditions.

Third, friction between slider 5 and base 9 (FIG. 1A) should be balanced by friction developed by some slippage between billet 8 and slider 5. This friction increases extrusion load and pressure, induces non-uniformity of strains and material properties, and may lead to laps at the bottom billet surface.

It would be desirable to minimize and, if possible, eliminate these negative effects and transform slider friction into backpressure, which improves material properties and workability. As it was described in U.S. Pat. No. 5,400,633, the problem can be resolved by providing the bottom slider with a protrusion overlapping the horizontal channel. However, such complicated tool has not found practical applications because of difficulties with billet ejection from the die into the extrusion direction.

### SUMMARY OF THE INVENTION

One object of the present invention is to minimize and attempt to eliminate the barreling at the front billet end. This reduces and preferably eliminates any need to reshape the billet after each pass. The bottom slider has a protrusion or upstanding wall that extends upwardly from the bottom slider. The protrusion overlaps the horizontal channel. During extruding, the protrusion with the die creates a die cavity. The slider moves together with the material as it is extruded, and the billet preserves its rectangular shape at any moment during the extrusion process.

In one embodiment, the billet, after extruding, is ejected in the opposite direction to the extrusion direction.

A method of one embodiment of the present invention comprises processing steps (FIGS. 3A-3E), which control slider and punch positions necessary for billet insertion into the die before extruding and billet ejection after extruding. To insert billet into the die, the punch is fully retracted and slider is moved to an original position where the protrusion covers or closes an exit cross-section of the vertical channel (FIG. 3A). During extruding, the punch is moved until it reaches a top surface of the horizontal channel (FIG. 3Bb). The slider is moved in an extrusion direction together with the material. After completion of a working stroke, the punch partly retracts and slider is moved into the extrusion direction until the slider fully releases from the bottom billet surface (FIG. 3C). Then, the punch moves down, ejects the billet from the horizontal channel (FIG. 3D) and fully retracts. The slider returns to the original position and eject billet from the tool in the direction opposite from the extrusion direction (FIG. 3E).

According to another embodiment of the present invention, there is provided a method for the extruding of material billets by equal channel angular extrusion, comprising the steps of inserting a billet into a metal channel of a die having vertical and horizontal channels. The horizontal channel is defined in part by a moveable slider. A force is exerted on the billet to extrude it through the vertical and horizontal channels. The slider is moved in an extrusion direction with the billet as the billet is extruded through the horizontal channel. The billet is ejected from the die in a direction opposite to the extrusion direction.

According to another embodiment of the present invention, there is provided a device for equal channel angular extrusion. The device includes a die having a vertical channel and a horizontal channel. The horizontal channel is defined at least in part by the moveable slider. The tool includes a moveable slider. The slider is moveable in a first extrusion direction during the extrusion of the billet. The slider is moveable in a second direction opposite the extrusion direction to eject the billet from the tool.

Another object of the present invention is trimming of a flash formed at the top billet surface during each pass. For this goal, a method of ECAE comprises a step of providing a trimming knife fixed in the base at a corresponding distance from a billet sliding surface, and a step of trimming the flash from the billet during billet ejection from the die.

### BRIEF DESCRIPTION OF THE DRAWINGS

FIG. 1A is a schematic diagram of processing a step for equal channel angular extrusion of billets according to the prior art in an original position;

FIG. 1B is a schematic diagram of a processing step for equal channel angular extrusion of billets according to the prior art after completion of an extrusion stroke;

FIG. 1C is a schematic diagram of a processing step for equal channel angular extrusion of billets according to the prior art showing release of the billet;

FIG. 1D is a schematic diagram of a processing step for equal channel angular extrusion of billets according to the prior art showing the billet ejected from the horizontal channel;

FIG. 1E is a schematic diagram of a processing step for equal channel extrusion of billets according to the prior art showing the billet ejected from the die;

FIG. 2 is a perspective view of an extruded flat billet according to the prior art;

FIG. 3A is a schematic diagram of a processing step for equal channel angular extrusion of billets according to the invention in an original position;

FIG. 3B is a schematic diagram of a processing step for equal channel angular extrusion of billets according to the present invention after completion of an extrusion or work stroke;

FIG. 3C is a schematic diagram of a processing step for equal channel angular extrusion of billets according to the present invention showing retraction of the punch;

FIG. 3D is a schematic diagram of a processing step for equal channel angular extrusion of billets according to the present invention showing the billet ejected from the horizontal channel;

FIG. 3E is a schematic diagram of a processing step for equal channel extrusion of billets according to the present invention showing the billet ejected from the die.

FIG. 4 is a perspective view of an extruded flat billet according to the invention; and

FIG. 5 shows a cross-sectional view of an ECAE die.

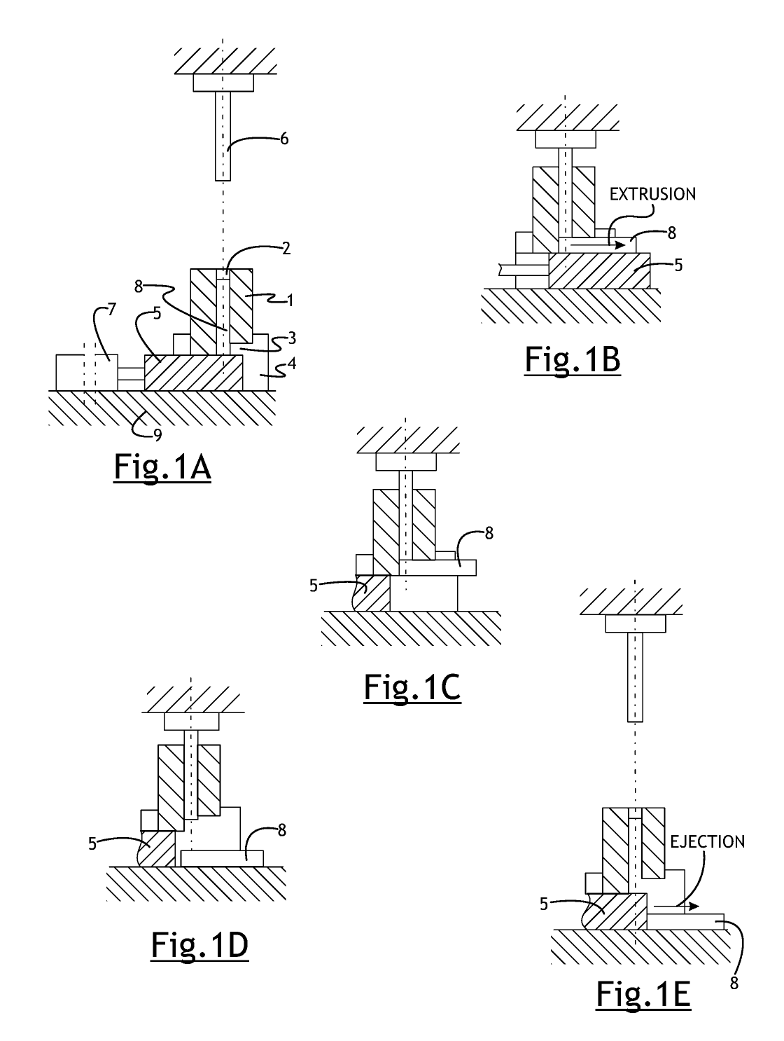

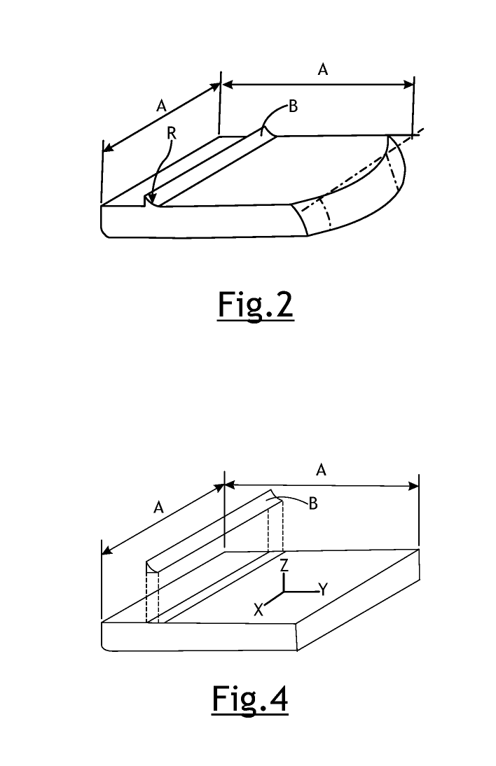

### DETAILED DESCRIPTION OF THE INVENTION

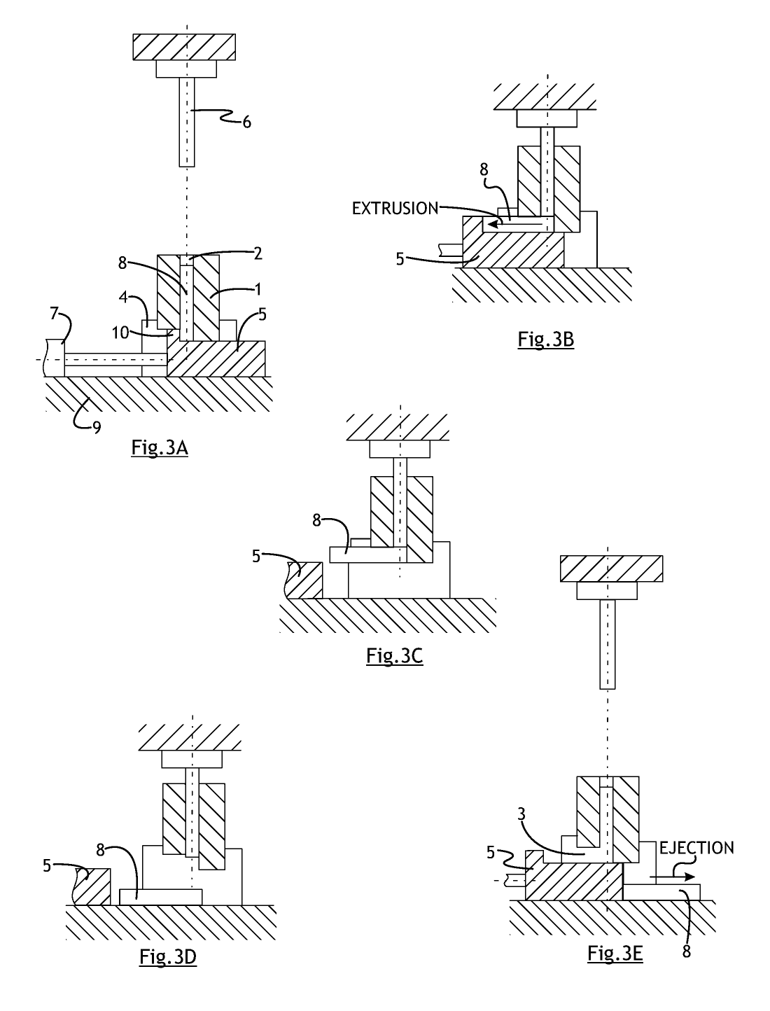

An embodiment of the invention will be described in details with reference to accompanying drawings. FIGS. 3A-E show schematically the processing steps of the invention. The method comprises extruding of a billet 8 from a vertical channel 2 into a horizontal channel 3 (FIG. 3A) of identical cross-section areas. The vertical channel 2 is formed in a die 1. A horizontal channel 3 is formed between die 1 and slider 5. The die is fixed into a base 4 which is mounted on a bottom plate 9. The slider 5 includes a protrusion or upstanding wall 10. The slider 5 can be moved relative to a base plate 9 by a hydraulic cylinder 7 and moveable position.

Extruding is performed by a punch 6 attached to a press traverse. The punch 6 is moveable vertically into the vertical die cavity.

Originally (FIG. 3A), the cylinder 7 moves the slider 5 via the piston into a limit right position, in which the protrusion 10 aligns with a vertical wall of the die to close the vertical channel 2. The punch 6 is in a retracted position above the vertical channel 2 and a well-lubricated billet 8 is inserted into the channel 2.

During a working stroke, the punch 6 moves downwardly and into the vertical channel 2, acting on the billet 8 and extrudes it into a horizontal channel 3 that is formed between the vertical wall of the die 1 and the slider 5. Simultaneously, the billet 8 acts on or pushes against the protrusion 10 and moves the slider 5 in the extrusion direction (to the left as viewed in FIG. 3B). The slider 5 confines the billet on the side edges and end edge of the billet. At the end of the stroke of the punch 6, the punch 6 reaches the upper wall of the horizontal channel as shown in FIG. 3B.

At the next processing steps, the punch 6 is slightly retracted or moved upwardly a small distance to relieve the billet 8 located into the horizontal channel (FIG. 3C). The cylinder 7 via the piston moves the slider 5 to a limit left position until full relieve of the billet 8 (FIG. 3C). That is, the slider 5 is moved in the extrusion direction (to the left as viewed in FIG. 3C) until it is clear of the billet 8 and no longer contacts the billet 8. Then the punch 6 moves down and ejects billet 8 from the horizontal channel (FIG. 3D) onto the bottom plate 9. At the final step, shown in FIG. 3E, the cylinder via the piston returns the slider 5 to the original position and ejects the billet from the die. The slider 5 is moved in the opposite direction as the extrusion direction to the right as shown in the Figures to eject the billet 8 from the die. To further process the billet 8, if desired, the billet 8 can them be removed from the die, and may be rotated and placed back into vertical channel 2 another pass through the die. Once the desired properties of the billet 8 have been achieved, the billet can be removed from the die and no further passes may be needed.

Therefore, in contrast to the prior art, the present embodiment of the die and method provides ECAE into closed or contained vertical and horizontal channels that greatly reduces and may eliminate material barreling. This preserves the rectangular billet shape after each pass. Friction between the slider 5 and the base plate 9 is balanced by normal pressure (FIG. 3B), which the extruded material billet applies directly to the slider 5 by acting on the protrusion 10. In turn, these stresses act on the material as a backpressure, which increases the billet material ductility and prevents cracks. During extruding, the billet material 8 and slider 5 move together at the same speed without any slippage and with zero friction providing the most effective processing for structure refinement.

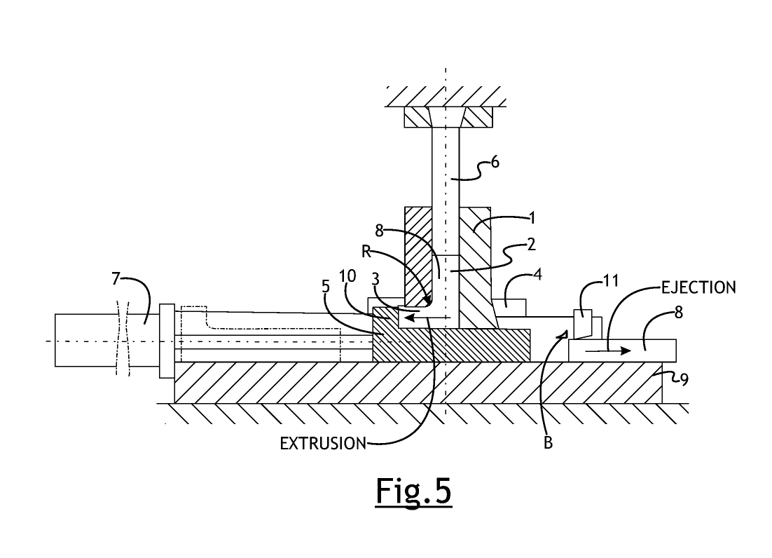

Another embodiment of the present invention is trimming of the flash formed at the top billet surface simultaneously with billet ejection. FIG. 5 depicts the ECAE tool comprising die 1, base 4, slider 5 with protrusion 10, punch 6, hydraulic cylinder 7, and base plate 9. As shown, the die 1 includes a radiused corner R on the lower edge of a vertical wall thereof at the junction of the vertical and horizontal channels. This radius R helps reduce cracks in the billet. The tool is provided with a knife 11 fixed into the base 4. During the step of the billet ejection (FIG. 3E), the slider 5 pushes the billet 8 under the knife 11 and trims the flash. FIG. 5 shows a plate billet 8 together with trimmed flash B after ejection of the billet according to this embodiment.

The billet 8 has a rectangular shape with a correct length A in both directions and a flat top surface without barreling of the front end. Such billet typically does not need additional operations of reshaping, cleaning or machining between passes and can be reinserted into the die after any rotation about axis X, Y or Z. Respectively, multi-step processing pass-by-pass can be performed at warm or hot temperatures without necessity for billet cooling and reheating between passes.

The method improves productivity and material quality, and reduces cost of ECAE processed materials including large-scale billets for many applications.

What is claimed is:

1. A method for extruding of material billets by equal channel angular extrusion comprising the steps of:
inserting a billet into a vertical channel of a die having vertical and horizontal channels, the horizontal channel defined in part by a moveable slider;
exerting a force on the billet to extrude it through the vertical and horizontal channels;
moving the slider in an extrusion direction with the billet as the billet is extruded through the horizontal channel; and
ejecting the billet from the die in a direction opposite to the extrusion direction.

2. In a method for extruding of material billets by equal channel angular extrusion, an improvement for cost effective multi-pass processing without billet reshaping and reheating, comprising the steps of:
providing an extrusion apparatus with a base mounted at the bottom plate, a punch, a die having contiguous vertical and horizontal channels of the identical cross-sectional area, a slider operated by a hydraulic cylinder, which forms the bottom wall of the horizontal channel and has a protrusion overlapping the channel;
providing the material billet of the identical cross-section area with channels;
moving the slider to the original position in which the slider protrusion coincides with an entrance section of the horizontal channel and locks the vertical channel;
inserting the well-lubricated preheated or cold billet into the vertical channel;
extruding the billet by the punch from the vertical channel into the horizontal channel till punch attains the top wall of the horizontal channel;
slightly moving the punch up;
moving the slider into an extruding direction till slider releases fully the billet bottom surface;
moving the punch down and ejecting the billet from the horizontal channel; and
moving the slider to the original position and ejecting the billet from the die into an opposite direction to the extruding direction.

3. A method of equal channel angular extrusion, comprising the steps of:
providing an extrusion apparatus with a base mounted at the bottom plate, a punch, a die having contiguous vertical and horizontal channels of the identical cross section area, a slider operated by a hydraulic cylinder, which forms the bottom wall of the horizontal channel and has a protrusion overlapping the channel, and a trimming knife;
providing the material billet of the identical cross-section area with channels;
moving the slider to the original position in which the slider protrusion coincides with the an entrance section of the horizontal channel and locks the vertical channel;
inserting the well-lubricated billet into the extrusion channel;
extruding the billet by punch from the vertical channel into the horizontal channel till punch attains the top wall of the horizontal channel;
slightly moving the punch up;
moving the slider into an extruding direction till full release of the billet;
moving the punch down and ejecting the billet by punch from the horizontal channel;
moving the slider to the original position and ejecting the billet from the die into an opposite direction to the extrusion direction; and
trimming a flash at the top billet surface by the knife, which takes place simultaneously with billet ejection from the die.

4. A device for equal angular extrusion comprising:
a die defining a vertical channel and a horizontal channel;
a moveable slider, the moveable slider defining at least in part the horizontal channel; and
the slider moveable in a first extrusion direction during extrusion of the billet and moveable in a second direction opposite the extrusion direction to eject the billet from the tool.
